(19) United States
(12) Patent Application Publication
(10) Pub. No.: US 2026/0260567 A1
(43) Pub. Date: Sep. 3, 2026

(54) SURVIVAL SPACE™ Vehicle-to-Vehicle Repulsion System

(71) Applicant: Pankaj Kumar, Charlotte, NC (US)

(72) Inventor: Pankaj Kumar, Charlotte, NC (US)

(21) Appl. No.: 19/540,883

(22) Filed: Feb. 16, 2026

(51) Int. Cl. G08G 1/16

(52) U.S. Cl. CPC G08G 1/163; G08G 1/166

(57) ABSTRACT

A cooperative vehicle safety system mitigates collision severity in mixed-mass traffic by reallocating braking decision timing earlier than human reaction capability. Vehicles broadcast motion and mass data to an edge computing system that performs mass-weighted conflict assessments. When a Time-to-Collision threshold of 1.5 seconds is met, the system transmits mass-aware coordinated braking commands that prioritize earlier deceleration for heavier vehicles. The system creates an expanded Survival Space by reclaiming up to 293 feet of reaction distance at highway speeds, improving survivability without exceeding mechanical braking limits. The architecture includes on-vehicle repeller nodes with 5G-V2X transceivers operating in the 5.895-5.925 GHz band, integrated load cells for real-time mass profiling, and Gateway ECUs with cryptographic authentication capabilities for secure remote intervention.

### BACKGROUND OF THE INVENTION

### Problem Context and Baseline Conditions

The I-77/I-485 interchange represents one of North Carolina's most congested and high-risk freight corridors. I-485 sustains average daily traffic volumes between 110,000 and 135,000 vehicles, with commercial trucks comprising approximately 7% of total flow. I-77 sustains 7,000-9,000 trucks per day, creating persistent mixed-mass traffic conditions with elevated collision severity risk.

The system described herein is engineered specifically to mitigate mass-mismatch collision dynamics by creating an artificially expanded reaction and braking envelope, herein defined as the “Survival Space.”

### Physics of the Survival Space

At highway speeds, kinetic energy increases with the square of velocity:

KE=½mv²

A fully loaded 80,000-lb (36,287 kg) Class-8 tractor-trailer possesses orders of magnitude greater kinetic energy than a 3,000-lb (1,360 kg) passenger vehicle at the same velocity. In collision scenarios, this energy disparity results in structural override of passenger vehicle crumple zones, rendering traditional braking-only safety systems insufficient.

### BRIEF SUMMARY OF THE INVENTION

The Survival Space™ system introduces five novel elements that, in combination, represent non-obvious, industrially applicable innovations not achievable through human reaction or conventional ADAS systems alone:

### Core Innovations

Temporal reallocation of reaction distance—Converting milliseconds of early detection into hundreds of feet of effective stopping distance

Mass-aware cooperative braking—Coordinated deceleration protocols that account for vehicle mass disparities in mixed-traffic scenarios

Cryptographically enforced brake authority negotiation—Secure handshake protocols that establish brake command authority between vehicles

Edge-accelerated MPC for mixed-mass traffic—Real-time Model Predictive Control executed at sub-10 ms intervals for multi-vehicle collision prediction

Franchise-scale safety infrastructure standardization—Standardized Repeller Hub blueprint enabling nationwide deployment with consistent performance metrics

### Patent Significance

These elements collectively address the fundamental physics limitation of human reaction time in high-kinetic-energy collision scenarios, providing a technological solution to mass-mismatch traffic safety that extends beyond conventional automotive safety systems.

### BRIEF DESCRIPTION OF THE DRAWINGS

FIG. 1 illustrates a high-level system architecture of the Survival Space vehicle-to-vehicle repulsion system.

FIG. 2 illustrates a main operational flowchart for the Survival Space vehicle-to-vehicle repulsion system.

### DETAILED DESCRIPTION OF THE INVENTION

Inventor Name: Pankaj Kumar
Inventor Address: 9532 Blue Knoll Ct, Charlotte, NC 28215
Professional Credentials: Master of Computer Applications
Citizenship: USA
Residence: USA

### Problem Context and Baseline Conditions

The I-77/I-485 interchange represents one of North Carolina's most congested and high-risk freight corridors. I-485 sustains average daily traffic volumes between 110,000 and 135,000 vehicles, with commercial trucks comprising approximately 7% of total flow. I-77 sustains 7,000-9,000 trucks per day, creating persistent mixed-mass traffic conditions with elevated collision severity risk.

The system described herein is engineered specifically to mitigate mass-mismatch collision dynamics by creating an artificially expanded reaction and braking envelope, herein defined as the “Survival Space.”

### Physics of the Survival Space

At highway speeds, kinetic energy increases with the square of velocity:

KE=½mv²

A fully loaded 80,000-lb (36,287 kg) Class-8 tractor-trailer possesses orders of magnitude greater kinetic energy than a 3,000-lb (1,360 kg) passenger vehicle at the same velocity. In collision scenarios, this energy disparity results in structural override of passenger vehicle crumple zones, rendering traditional braking-only safety systems insufficient.

Key Innovation: The Survival Space™ system introduces pre-impact temporal compression, converting milliseconds of early detection into hundreds of feet of effective stopping distance.

Quantified Survival Space Gains (65 MPH Baseline)

| | Standard | | Survival |
|---|---|---|---|
| | Human | Repeller System | Space |
| Metric | Reaction | Reaction | Gained |
| Reaction Distance | ~142.5 ft (1.5 s) | ~9.5 ft (0.1 s) | +133 ft |
| Braking Distance | ~300 ft | ~260 ft (Optimized | +40 ft |
| (Passenger Car) | | ABS) | |
| Braking Distance | ~600 ft | ~440 ft (Pneumatic | +160 ft |
| (Heavy Truck) | | Bypass) | |
| Total Stopping | N/A | N/A | Up to 293 ft |
| Distance | | | |
| Reduction | | | |

Key Insight: The system does not “stop vehicles faster”; it moves the decision point earlier in time, where physics becomes survivable.

### Architectural Description

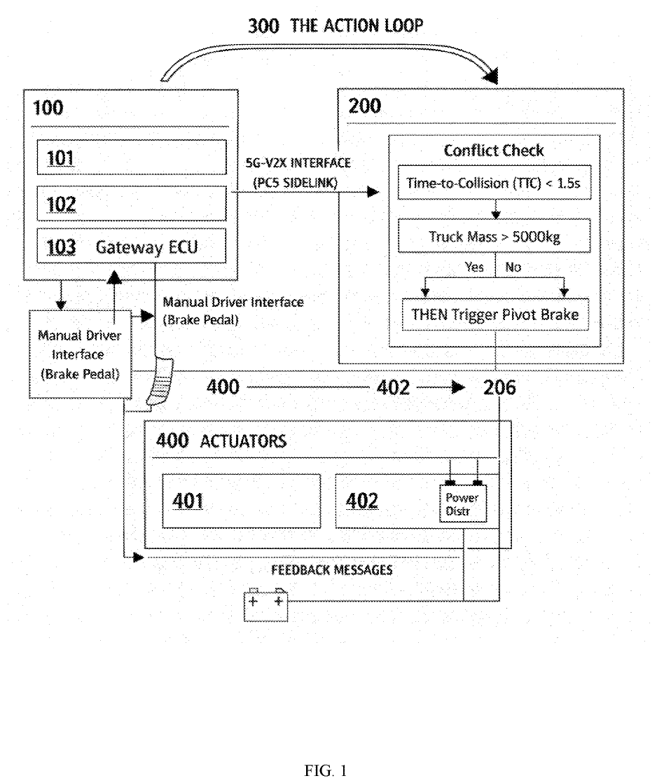

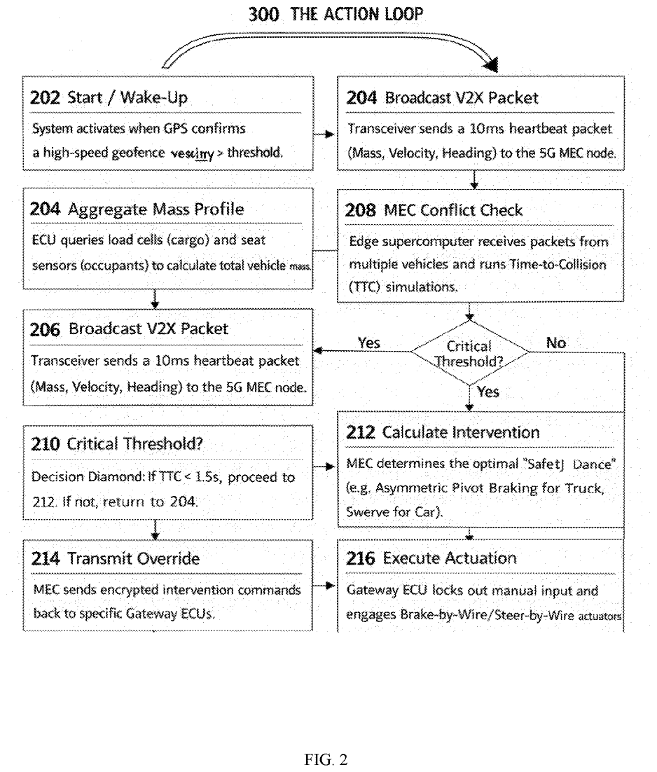

### Explicit FIG. 1↔FIG. 2 Operational Linkage

Referring to FIG. 1, the system comprises a plurality of On-Vehicle Repeller Nodes (100) configured to measure an instantaneous kinetic mass profile of the vehicle, including cargo and occupant loading, via a suite of load cells and occupancy sensors (101) integrated with the vehicle platform.

An Edge Safety Orchestration Layer (200) is communicatively coupled to the plurality of On-Vehicle Repeller Nodes (100) and is configured to execute the operational sequence illustrated in FIG. 2, including receiving the kinetic mass profile and associated vehicle state data to compute a mass-weighted conflict severity score for one or more predicted vehicle interactions.

In executing the conflict detection step shown in FIG. 2, the MEC Conflict Check (208) of the Edge Safety Orchestration Layer (200) is configured to process multidimensional state data streams from hundreds of simultaneously participating vehicles, including relative velocity vectors, trajectory envelopes, and mass classifications, at sub-10 millisecond evaluation intervals.

Such real-time, high-dimensional predictive analysis across a dynamically changing multi-vehicle system is physically impossible for the human mind to perform, thereby necessitating the automated, edge-accelerated computation described herein to achieve the reaction-time reallocation required to create the Survival Space.

As shown in FIG. 2, upon detection of a Critical Threshold (210)—including a time-to-collision value below a defined survivability limit—the Edge Safety Orchestration Layer (200) transmits an encrypted override command to a vehicle Gateway Electronic Control Unit (ECU) (103).

The Gateway ECU (103) is configured to selectively actuate Asymmetric Pivot Braking (212) through a brake-by-wire actuator (401), such that a controlled modification of the vehicle's trajectory and deceleration profile is executed. This coordinated actuation creates a Survival Space (Section 1.3) comprising at least 133 feet of recovered reaction distance relative to human response latency, thereby increasing collision survivability without exceeding mechanical braking limits.

### Design Principle

The architecture is hierarchically fault-tolerant:
Local vehicle autonomy remains functional without cloud access
Edge nodes enhance reaction speed but are non-critical for baseline safety
Cloud services provide optimization, analytics, and billing—not real-time control
Flowchart Narrative
Step-By-Step Execution Logic

### Step 1—Continuous State Broadcast

Each Repeller-equipped vehicle broadcasts:
Velocity vector
Mass class (hashed)
Brake system state
Trajectory confidence envelope
Broadcast rate: 20-50 Hz

### Step 2—Threat Envelope Prediction

Using MPC algorithms, the system calculates:
Time-to-collision (TTC)
Overlap probability between trajectories
Mass-weighted impact severity score

### Step 3—Safety Handshake Initiation

When TTC falls below a dynamic threshold:
Vehicles exchange cryptographically signed Safety Handshakes
Handshake includes:
Intent confirmation
Brake authority limits
Fail-safe parameters

### Step 4—Coordinated Brake Pre-Charge

Upon handshake validation:
Passenger vehicles pre-charge ABS systems
Heavy trucks engage pneumatic brake bypass
Engine braking and retarders are pre-armed
Critical Performance Gain: This step alone yields >130 ft of reaction distance recovery.

### Step 5—Controlled Deceleration Execution

If collision probability remains non-zero:
Brake commands execute in mass-aware priority order
Trucks decelerate earlier but more gradually
Passenger vehicles decelerate later but more aggressively

### Step 6—Post-Event Resolution

System transitions to:
Manual control restoration
Event logging
Anomaly flagging for Repeller Hub diagnostics
United States Scaling (State-to-State)
Regulatory Alignment
Operates within 5.895-5.925 GHz V2X band
Designed to comply with FCC safety-critical waivers
Federal Funding Compatibility
Eligible for:
SMART Grants CMAQ funding
Classified as a fatality-reduction technology, addressing ~43,000 annual U.S. traffic
deaths
Interstate Interoperability
All Repeller Nodes utilize standardized MIMO MPC kernels
A Repeller-Ready truck in North Carolina interoperates seamlessly with:
Virginia DOT edge nodes
Georgia 5G safety corridors
Canada Scaling (Cross-Border Integration)
Alignment with Canada's 2026 Automotive Strategy
Supports 75% EV adoption target by 2035
Reduces:
Hard braking events
Stop-and-go congestion
Brake particulate emissions
GHG Harmonization
Survival Space™ is positioned as:
A safety system
An emissions-reduction efficiency system
Cross-Border Repeller Hubs
Initial hubs in Ontario
Coordinated with provincial automotive task forces
Supports North American freight corridors without hardware redesign
The “Standard Repeller Hub” Blueprint
Each certified hub must include:
Hardware Certification
Identical HIL rigs used in Charlotte pilot
Simulated multi-vehicle collision environments
Brake system latency verification
Software as a Service (SaaS) Platform
Unified Safety Handshake monitoring
Flat $0.02 per-mile commercial fleet levy
Automated compliance reporting
Cybersecurity Mandate
PKI-based identity authentication
Hardware-rooted encryption modules
Protection against:
Brake signal hijacking
Replay attacks
Cross-vehicle spoofing

What is claimed is:

1. A cooperative vehicle safety system, comprising at least one on-vehicle repeller node (100) installed on a vehicle, including a 5G-V2X transceiver (102) and a suite of load cells and occupancy sensors (101), said sensors (101) configured to generate a real-time kinetic mass profile of the vehicle, an edge computing system (200) configured to receive state data from multiple vehicles via a PC5 Sidelink interface, the edge computing system (200) configured to calculate a time-to-collision (TTC) value and a mass-weighted collision severity metric, and the edge computing system (200) configured, upon determination that the TTC satisfies a critical threshold, to transmit coordinated braking or deceleration commands to a Gateway ECU (103).

2. A method for cooperative collision mitigation in mixed-mass traffic, comprising continuously broadcasting vehicle state data including a velocity vector and a hashed mass class at a rate of at least 20 Hz, predicting a threat envelope by calculating a mass-weighted impact severity score at an edge orchestration layer, initiating a cryptographically authenticated Safety Handshake when a trajectory overlap probability exceeds a safe threshold, executing a coordinated brake pre-charge of Brake-by-Wire (401) actuators to recover reaction distance, and performing controlled deceleration in a mass-aware priority order to create a Survival Space of reclaimed reaction distance.

3. A vehicle gateway apparatus for remote safety intervention, comprising a secure interface configured to receive encrypted intervention commands from a 5G edge node, a logic processor configured to compare remote intervention commands against local manual driver inputs, a command override module configured to lock out manual inputs upon validation of an intervention command, and a haptic feedback module configured to signal control restoration to a driver via a manual driver interface.

4. The system of claim 1, wherein the coordinated braking commands are mass-aware such that heavier vehicles initiate deceleration earlier than lighter vehicles.

5. The system of claim 1, wherein the system reallocates reaction timing earlier than human reaction latency without increasing maximum braking force.

6. The system of claim 1, wherein the 5G-V2X transceiver operates within the 5.895-5.925 GHz band.

7. The system of claim 1, wherein the load cells are integrated into vehicle suspension struts to register dynamic cargo weight.

8. The system of claim 1, wherein the critical threshold is a TTC of less than 1.5 seconds.

9. The system of claim 1, wherein the edge computing system performs real-time Model Predictive Control (MPC) with a round-trip latency of less than 10 ms.

10. The system of claim 1, wherein the Gateway ECU (103) is configured to override manual driver interface inputs to actuate the Actuators (400).

11. The method of claim 2, wherein the coordinated brake pre-charge recovers at least 130 feet of reaction distance relative to human response.

12. The method of claim 2, wherein the Safety Handshake includes exchange of intent confirmation and brake authority limits.

13. The method of claim 2, further comprising engaging a pneumatic brake bypass in heavy trucks to reduce air brake lag.

14. The method of claim 2, further comprising returning control authority to a driver and logging event telemetry to a certified Repeller Hub after neutralizing the threat.

15. The method of claim 2, wherein the controlled deceleration comprises a “Safety Dance” including asymmetric pivot braking for trucks and coordinated lane positioning for passenger vehicles.

16. The method of claim 2, wherein the state data broadcast includes a trajectory confidence envelope.

17. The apparatus of claim 3, further comprising a cryptographic identity module for PKI-based authentication of 5G signals.

18. The apparatus of claim 3, wherein the apparatus is configured to pre-arm engine braking and retarder systems.

19. The apparatus of claim 3, wherein the apparatus is hierarchically fault-tolerant to maintain local autonomous safety in the absence of edge node connectivity.

20. The apparatus of claim 3, wherein the apparatus is calibrated at a Repeller Hub using Hardware-in-the-Loop (HIL) simulation.
